(19) United States
(12) Patent Application Publication
(10) Pub. No.: US 2025/0332608 A1
(43) Pub. Date: Oct. 30, 2025

(54) MASKLESS ROBOTIC DEPOSITION SYSTEM

(71) Applicant: Figure, Inc., Lorton, VA (US)

(72) Inventors: Leonard McCreary, Lorton, VA (US); Camille Jones, Lorton, VA (US); Kurt Clothier, Lorton, VA (US); Dariusz Startek, Lorton, VA (US); Gabriel Rodriguez, Lorton, VA (US); Chris Holtzclaw, Lorton, VA (US)

(21) Appl. No.: 18/651,571

(22) Filed: Apr. 30, 2024

(51) Int. Cl. B05C 11/10; B05C 11/105; B25J 11/00

(52) U.S. Cl. CPC B05C 11/1013; B05C 11/105; B25J 11/0075

(57) ABSTRACT

Disclosed are droplet deposition systems. The systems regulate the pressure of the system by, for example, coordinating the pressure provided by a pressure source with the pressure released when a droplet is dispensed. Alternatively, or in addition to the above, a pressure regulator may be used to maintain the coating liquid in equilibrium and permitting the dispensation of a droplet when a piston actuator contacts a micropipe. A robotic arm can be used to apply the coating to a substrate, such as a military aircraft.

### STATEMENT ON FEDERALLY SPONSORED RESEARCH OR DEVELOPMENT

This invention was made with government support under grant numbers FA8571-21-C-0031 and FA8571-20-C-0006 awarded by Air Force SBIR. The Government therefore has certain rights in the invention.

### FIELD OF THE INVENTION

The presently disclosed embodiments relate to painting technology. In particular, the presently disclosed embodiments relate to a robotic, maskless painting system that provides small droplets of paint on demand.

### BACKGROUND

Traditional painting methods in the aerospace and defense sectors have predominantly relied on techniques involving manual or automated spraying, roller applications, and brush painting. These conventional methods, while effective for broad coverage, often require the use of masks or stencils to create specific designs or to paint designated areas, particularly in applications requiring high precision and accuracy. The masking process is not only time-consuming and labor-intensive but also generates significant waste due to excess paint and masking materials. Furthermore, the risk of paint bleed or over-spray can compromise the precision and quality of the final product.

Additionally, conventional painting techniques do not efficiently cater to the need for miniaturization and precision in contemporary aerospace and defense applications. As the industry moves towards more sophisticated and complex designs, especially in avionics and camouflage technology, there is an increasing demand for a painting method that offers finer control at a microscopic level.

### SUMMARY

The presently disclosed embodiments relate to droplet deposition systems that dispense a coating by contacting a piston actuator against a pipe or channel in a pressure-controlled system. For example, the pressure may be controlled through the coordination of a pressure source providing pressure while the piston actuator releases pressure by causing the dispensation of the droplets. Alternatively, or in addition to the above, the system may include a pressure regulator that provides a small amount of pressure to allow the coating to refill by capillary action, but without providing enough pressure to cause the droplets to be dispensed without the piston actuation. A robotic arm can be used to move the system to an appropriate location on a substrate for dispensation of the droplets thereon.

For example, the presently disclosed embodiments can include a coating deposition system for dispensing a coating, the coating deposition system comprising a robotic arm; and an applicator coupled to and movable by the robotic arm, the applicator including a container that maintains the coating in a closed configuration, a pressure restoration system that adjusts a pressure within the container at a time proximate to when a droplet is dispensed by the applicator, a conduit including at least a first opening coupled to the container for receiving the coating and a second opening where the droplet exits the applicator, and a piston actuator located proximate the conduit and releasing pressure within the conduit upon receipt of an electrical signal.

In some embodiments, the pressure restoration system includes a pressure regulator, wherein displacement of the droplet causes activation of the pressure regulator to replenish pressure lost from the applicator upon dispensation of the droplet.

In some embodiments, the pressure restoration system includes a pump, wherein displacement of the droplet causes activation of the pump to replenish pressure lost from the applicator upon dispensation of the droplet.

In some embodiments, the coating deposition system further comprises a computer with a storage and processor, the processor capable of executing instructions to cause the piston actuator to release the pressure in the conduit so as to cause dispensation of the droplet, and cause the activation of the pump to replenish the pressure lost from the applicator upon the dispensation of the droplet in a coordinated manner.

In some embodiments, the pump is at least one of a syringe pump including a motor coupled to a linear actuator, a pneumatically driven syringe, and a pneumatically driven pressure regulator.

In some embodiments, the conduit is a microstructure and wherein the coating passes through the microstructure at least in part due to capillary action.

In some embodiments, the applicator includes a plurality of jets each including respective piston actuators and conduits, the jets at least in part positioned in a staggered arrangement.

In some embodiments, the piston actuator is positioned adjacent the conduit and contacts the conduit so as to apply a force against the conduit and release the pressure from the conduit.

In some embodiments, the piston actuator is placed in a rest position and releases the pressure from the conduit when removed from the rest position.

In some embodiments, the conduit includes a casing proximate the second opening.

For example, the presently disclosed embodiments can also include an applicator for a coating deposition system that dispenses a coating, the applicator comprising a container that maintains the coating in a closed configuration, a pressure restoration system that adjusts a pressure within the container at a time proximate to when a droplet is dispensed by the applicator, a conduit including at least a first opening coupled to the container for receiving the coating and a second opening where the droplet exits the applicator, and a piston actuator located proximate the pipe and releasing pressure within the conduit upon receipt of an electrical signal.

In some embodiments, the applicator further comprises a computer with a storage and processor, the processor capable of executing instructions to cause the piston actuator to release the pressure in the conduit so as to cause dispensation of the droplet, and cause the activation of the pump to replenish the pressure lost from the applicator upon the dispensation of the droplet in a coordinated manner.

In some embodiments, the applicator further comprises a plurality of jets each including respective piston actuators and conduits, the jets at least in part positioned in a staggered arrangement.

### BRIEF DESCRIPTION OF THE SEVERAL VIEWS OF THE DRAWINGS

The present technology will be described with reference to the appended drawings. The drawings aid in the description of the present technology and are not to be considered to be limiting the scope of the appended claims. The accompanying drawings include:

FIG. 1 illustrates robotic deposition systems applying a coating such as paint to an aircraft, according to at least some of the presently disclosed embodiments.

FIG. 2A illustrates a position displacement applicator according to at least some of the presently disclosed embodiments.

FIG. 2B illustrates a pressure-regulated applicator according to at least some of the presently disclosed embodiments.

FIGS. 3A-3E illustrate different configurations for a piston actuator applying force to a conduit according to at least some of the presently disclosed embodiments.

FIG. 4 illustrates two sweeps of a staggered print head configuration according to at least some of the presently disclosed embodiments.

FIG. 5 illustrates a suction cup gantry according to at least some of the presently disclosed embodiments.

FIG. 6 is a flow chart illustrating a process for depositing coating according to at least some of the presently disclosed embodiments.

FIG. 7 is a schematic diagram of the system architecture of the robotic deposition system according to at least some of the presently disclosed embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Steve Jobs famously addressed a common misconception in product development, calling it a “disease.” He often referred to it as “the disease of thinking that a really great idea is 90% of the work,” highlighting the issue that “there is just a tremendous amount of craftsmanship in between a great idea and a great product.”

The presently disclosed embodiments will discuss both the “really great idea” and the “craftsmanship” required to bring it to life. Indeed, the inventors conducted extensive testing, encountered unimaginable challenges, and solved countless problems throughout the inventive process. Below is a discussion of that “craftsmanship,” followed by a more traditional explanation of the structural and procedural aspects of the technology.

### The Inventors' Experiments and Testing

The inventors recognized that paint and other coatings have viscosity, density, and surface tension properties that play a role in micro-fluidics, such as the pipe and pipe tip. The inventors performed several experiments that dispensed Mil-prf-85285 2 k paint at different times to characterize the actuator-driven piston's pulse width amplitude, duration, and the rate of ascension and descension needed to overcome the challenges that these properties create. The properties would change over time due to the active cure of the paint. To this end, the inventors ran material characterization tests to map the change in surface tension, density, and viscosity based on the amount of thinner in the paint formulation and paint aging time. Additionally, they changed the pulse properties of the piston actuator to determine effective properties to implement for a given paint.

Initial experiments used a pressurized air over fluid system to deliver fluid to the conduits for deposition. In this system, air pressure was used to push the amount of fluid needed for the desired droplet size at the precise time the piston-driven piston triggered to dispense the droplet. This pressure system was “open” in that the piston actuator delivered the paint by squeezing it out of the conduit. The inventors discovered that the orientation of the paint reservoir would benefit from remaining stationary, otherwise the change in head pressure would cause errors during the printing process. Most robotic paint systems require a stationary reservoir at the base of the robot, and the paint is then pumped from that base to the end effector. Accordingly, the inventors designed at least one embodiment to be modular, scalable, and mobile at the lower end of the scale. They found that by using a displacement-based system or capillary based fluid delivery system, they could have greater flexibility in the orientation of the print and placement of the fluid, and even the direction of the end effector.

The inventors built a custom syringe pump driven by a stepper motor and tested the ability to displace nanoliter amounts of fluid in sync with the piston trigger. Testing showed it would be beneficial to use microstepping with the stepper motor to achieve a precise flow rate. It was shown that several other factor beyond precision of amount of fluid can be controlled with beneficial results. For example, the inventors ran tests that varied the motion profile of the step motor with both a linear and nonlinear profile. If the motion profile required a sharp ramp up to speed, the syringe plunger would jerk and prematurely cause an influx of fluid. There were also compounded signal delays, syringe plunger reactions, and fluid reaction delays. To test synchronization, the inventors incorporated methods to iterate time delays on the order of milliseconds to compensate for the above delays. They also found that elasticity in the material can cause variability. As the system components compressed and expanded, the forces from this action acted as a micropump that either pushed or pulled the fluid. The inventors tested multiple types of fixtures, syringe materials, and tubing material to reduce the elasticity in the system.

Later experiments also used an air over fluid system that maintained a constant low pressure in the system. In this experiment, the system was a capillary-driven fluid delivery system. Unlike the displacement and pressure driven systems, the flow of the paint here was solely determined by the actuated piston. The precisely controlled, low pressure in the reservoir encouraged refilling of the pipe through capillary action. This pressure was high enough to encourage reservoir refilling through capillary action whenever a droplet was dispensed by the actuator-driven piston, but low enough where capillary resistance could resist the pressure to prevent premature paint leakage from the pipe. In this system, the reservoir had an internal chamber where the paint was forced to travel up before being fed into the dispensing conduit, and thus head pressure remained the same or changed insignificantly as paint was consumed and the robot arm moved. Tests were conducted to determine the ideal pressure required to encourage this flow, which was determined primarily by the conduit diameter and length, the paint properties, the feed tubing, and the conduit material. Precise pressure control was required with pressures lower than or equal to 0.04 atmospheres. Unlike with the displacement-driven system, in this system, maximum paint flow was limited by capillary action and conduit dimensions. If the pulse rate reached a threshold, capillary refill was not fast enough and thus smaller droplets were delivered, leading to consistent maximum flow despite the pulse rate being increased.

This new system involved a relatively constant pressure and was “closed” in the sense that it included a closed valve. The pressure drove the droplets outward when the actuator piston was opened, because the piston was normally in the closed state and blocked paint from or pressure from exiting the system.

The inventors ran print speed tests using multiple heads. Given the space and material separating the conduits, it was shown by staggering the conduits a path could be both parallel and adjacent. Without staggering, the robot would need to “double back” to fill in gaps. This optimized raster fill paths and improved print speeds. The inventors also saw the limitations of raster motions for wrapped characters or curves. Specifically, rastering results in dead space. The robot provided flexibility to follow a curve on a contour surface while maintaining a constant standoff to reduce distortion. This led to enable both a raster and follow a curve or outline print style to create the most efficient print speed.

The inventors then ran droplet formation tests using a high-speed camera that monitored material creep, satellite droplet formation, the effects of tip contamination, and the contact angle. The inventors unexpectedly discovered that the surface tension of the fluid would cause the fluid to creep up the nozzle causing large drops to accumulate, especially when paint flow was mistimed with piston pulses. This test resulted in a design constraint to lower the area possible for creep and therefore relieve surface tension.

The inventors also ran a print trial on the underside of a surface in which deposition completely opposed gravity. They found that an open system susceptible to gravity effects does not work well unless stabilized using a gyroscope.

The inventors also ran a synchronization test between the robot and the droplet on demand dispensing end effector. The test followed a curve on a contour surface. Initial test results matched the programmed linear speed of the robot with a constant piston trigger frequency converting programmed linear speed to the frequency of the piston trigger. This was feasible given there was sufficient time and runway to ramp up to a constant speed. These runways are known as “lead ins” and “lead outs.” The inventors found that, for small details with a short length, the robot never reaches a constant speed. The robot also had to round corners leading to inhibiting sharp features. The inventors designed a work around that bisected corners and introduced larger leads, which resulting in slower cycle times. To remove the dependency of syncing speed with frequency, the inventors moved to a position-based trigger in which each path had a high density of points correlating to the density of the droplets. Each drop had an associated position. This involved real-time processing and streaming of robot parameters, syringe parameters, and piston parameters at each drop position.

### Description of Exemplary Embodiments

The presently disclosed embodiments relate to droplet deposition systems. The systems regulate the pressure of the system by, for example, coordinating the pressure provided by a syringe pump with the pressure released when a droplet is dispensed. Alternatively, or in addition to the above, a pressure regulator may be used to maintain the coating liquid in equilibrium and permit the dispensation of a droplet when a piston actuator triggers a conduit to dispense the droplet. A robotic arm can be used to move the system into position to apply the coating to a substrate, such as a military aircraft.

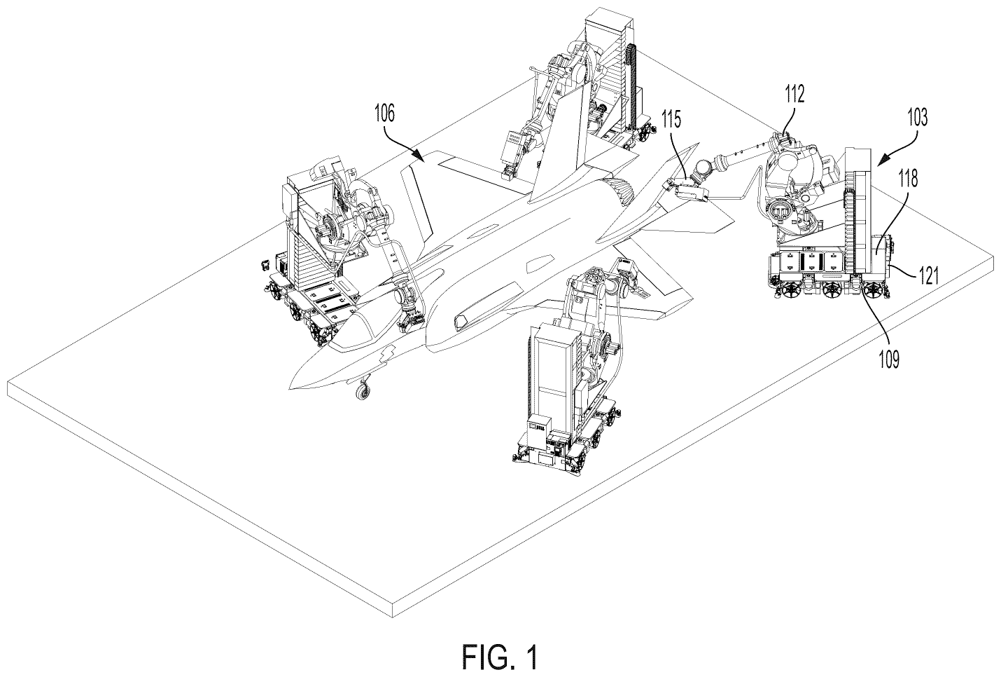

FIG. 1 illustrates robotic deposition systems and vehicles according to at least some of the presently disclosed embodiments. As shown, the systems 103 can be a coating deposition system that dispenses a coating, such as paint, on to a substrate 106, such as a military aircraft. The systems 103 can include a mobile base unit 109 that moves the system into an approximate position, and a robotic arm 112 that locates an applicator 115 with a print head in a more precise location, as well be discussed below in more detail. For example, the applicator 115 can be coupled to and movable by the robotic arm 112. Coupled to or associated with the mobile base unit 109 can be a coating reservoir 118 that holds the coating in place. A mobile computer 121 can also be associated with the mobile base unit 109 to provide the digital means for carrying out the deposition process.

The mobile base unit 109 can be any vehicle or mobile object capable of transporting the applicator 115 to an approximate position. For example, the mobile base unit 109 can be a wheeled cart, a track-driven platform, or a robotic walker. Additionally, the mobile base unit 109 may include various forms of locomotion such as self-balancing systems, hover technology, or even aerial drones capable of bearing weight. It could also be implemented as a modular attachment to existing machinery, enabling the retrofitting of traditional stationary devices into mobile units. The design may incorporate features such as autonomous navigation systems, manual control options, or remote operation capabilities to adapt to different operational environments and tasks.

The robotic arm 112 is coupled to the mobile base unit 109 and more precisely moves the applicator 115 into place. As will be discussed below in more detail, the mobile computer 121 can be provided with data identifying an origin of x,y,z=0,0,0 as a coordinate point for dispensing the coating to precise locations. Assuming the substrate is rigid and does not move, the mobile base unit 109 can move the applicator 115 to an approximate position relatively close to the area of the substrate 106 where the coating will be dispensed. Thereafter, the mobile computer 121 can use the coordinate system and the known origin to move the robotic arm 112 into a precise location for dispensation of the coating.

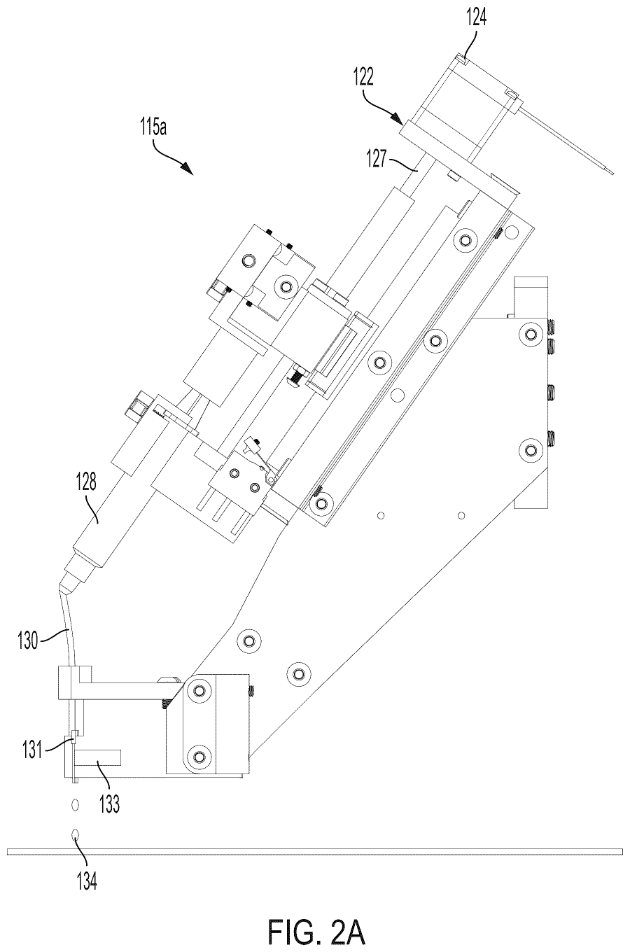

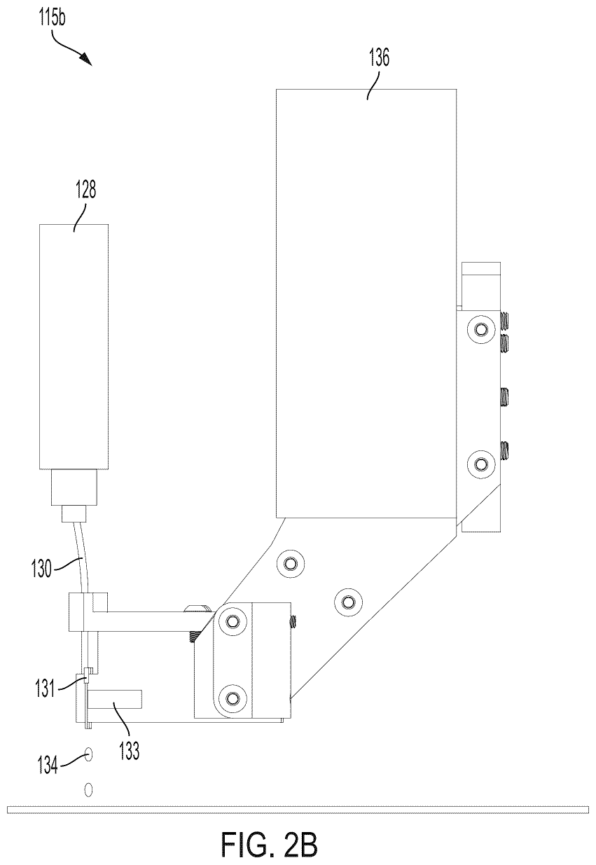

The applicator 115 acts as the functional mechanism that dispenses the coating to the substrate 106. As discussed further in FIGS. 2A and 2B, the applicator 115 utilizes a pressure-controlled system to dispense droplets on demand via a piston actuator. The applicator 115 can therefore provide precise dispensation control of the droplets in a relatively low-cost and controllable manner.

The coating reservoir 118 can be any housing or container capable of maintaining the coating in a contained position. For example, the coating reservoir 118 can be located closer to the base of the system 103, i.e., closer to the mobile base unit 109 and away from the robotic arm 112. This exemplary embodiment allows the coating reservoir 118 to maintain the coating in a contained position but away from the moving robotic arm 112. The inventors discovered that a stationary coating reservoir 118 allowed for more controlled and precise prints, because changes in print head pressure caused poor quality prints. Accordingly, positioning the coating reservoir 118 near the base of the system 103 allowed it to maintain its position while still dispensing coating to the applicator 115 through a series of pipes or hoses.

The mobile computer 121 can be any personal computer, controller, or computing technology that is capable of controlling the system 103 or otherwise receiving instructions from an external system and controlling the system 103 on the basis of those instructions. For example, the mobile computer 121 can include a storage for storing print data in a register, a processor for processing the print instructions, and a transceiver for communicating with external devices. The mobile computer 121 may also include various interfaces for direct user interaction, such as touchscreens or keyboards, allowing for manual input or adjustment of print settings. Further, the system can be configured to support a range of connectivity options including, but not limited to, Wi-Fi, Bluetooth, Ethernet, and USB, facilitating seamless integration with diverse network configurations and peripheral devices. This enables the mobile computer 121 to receive updates, monitor print jobs remotely, and coordinate with multiple third-party controllers or systems in a dynamic environment.

The mobile computer 121 is equipped with software tailored to interpret and convert incoming data into executable print commands. For example, the print data may include a series of 0's and 1's. For a print head with three jets, the 0 may indicate the print head is in the OFF configuration, while a 1 may indicate the jet is in the ON configuration. So, a data package of 1, 1, 0 would indicate the first two jets are on while the final jet is off, for example. Any other manner of communicating jet configurations can be implemented without departing from the spirit and scope of the presently disclosed embodiments.

FIG. 2A illustrates a position displacement applicator 115a according to at least some of the presently disclosed embodiments. As shown, the position displacement applicator 115a includes a pump 122, where displacement of the droplet 134 causes activation of the pump 122 to replenish pressure lost from the applicator 115a upon dispensation of the droplet 134. For example, the pump 122 can include a motor 124 that drives a linear actuator 127 to force air or fluid into the container 128, where coating is held. The air or fluid can then displace the coating within the container 128 and push it into a conduit 130 reinforced by a casing 131 at its end. A piston actuator 133 can then cause the dispensation of droplets 134 of the coating from the end of the conduit 130 using a variety of methods, as disclosed below in more detail.

The position displacement applicator 115a can function based on a coordinated effort between the motor 124 and piston actuator 133. Specifically, the position displacement applicator 115a can include or be associated with a computer with a storage and processor. The processor can be capable of executing instructions to cause the piston actuator 133 to contact the conduit 130 so as to cause dispensation of the droplet 134, and cause the activation of the pump 122 to replenish the pressure lost from the applicator 115a upon the dispensation of the droplet 134, where this process is conducted in a coordinated manner. In particular, the pump 122 can replenish the pressure in the system caused by the dispensation of the droplet 134 by the piston actuator 133. If the motor 124 provides too much pressure, it will cause the dispensation of droplets 134 when not instructed to do so. However, the conduit 130 may not have a droplet 134 to dispense if the motor 124 fails to provide the adequate amount of pressure into the system. The present inventors discovered that, while multiple pumps can be implemented, the motor 124 and linear actuator 127 could act as a syringe pump and provide very small amounts of pressure at well-defined time periods, allowing for the coordination of small amounts of pressure from the motor 124 and linear actuator 127 in conjunction with the dispensation of droplets 134 from the end of the conduit 130. For example, the mobile computer 121 could send an electrical signal to the piston actuator 133 to dispense droplets 134 from the end of the conduit 130, and at the same time or immediately following the dispensation, send a signal to the motor 124 to push the linear actuator 127 in such a manner as to cause the container 128 to replenish the pressure lost by the droplet 134. In this manner, drops of the coating can be provided on-demand and while minimizing the likelihood of excessive droplets 134 or poor-quality prints due to failed dispensation of a droplet 134.

The pump 122 can be any type of pump capable of providing pressure. For example, the pump 122 can be a syringe pump including the motor 124 coupled to the linear actuator 127, a pneumatically driven syringe, a pneumatically driven pressure regulator, or any other type of pump.

The motor 124 can be any motor capable of actuating the linear actuator 127 and causing a small increase in pressure within the container 128. For example, the motor 124 can be a stepper motor, a servo motor, a piezoelectric motor, or any other type of precision motor that allows for fine control over movement. The motor 124 could be configured to operate based on various input signals, such as electrical, hydraulic, or pneumatic, depending on the design requirements of the system. It may also include features such as feedback sensors for precise positioning, speed control systems to adjust the rate of actuation, and integrated circuits for automated control. Additionally, the motor can be designed to work with both alternating current (AC) and direct current (DC) power sources to accommodate different operational environments and ensure consistent performance under varying electrical conditions.

The linear actuator 127 can be any structural configuration that, together with the motor 124, can form a syringe pump. For example, the linear actuator 127 can be a screw-driven actuator, a hydraulic cylinder, a pneumatic piston, or an electromagnetic solenoid. It could also be designed as a rack and pinion system or incorporate a belt-driven mechanism to ensure precise movement and control. The structural design of the linear actuator 127 may feature advanced materials to enhance durability and performance under repeated use or high-pressure conditions.

The container 128 can maintain the coating in a closed configuration away from air or other factors that may cause premature curing or other undesirable characteristics. The container 128 may be equipped with a stirring mechanism that stirs the coating so as to avoid separation of the insoluble components of the coating. Although the container 128 is shown as a tube-shaped component, any shape container 128 may be implemented without departing from the spirit and scope of the present invention.

The conduit 130 can be any passageway allowing for the flow of liquid or gas. For example, the conduit 130 can be a pipe, channel, microstructure (e.g., micropipe or microchannel), or any other passageway through which the coating can be transmitted.

The casing 131 can provide structural reinforcement at the end of the conduit 130. The casing 131 can be advantageous because, in some embodiments, the piston actuator 133 contacts the conduit 130 for dispensation of the droplets 134. Naturally, repeated contact-based actuation by the piston actuator 133 can cause failure in the conduit 130 through fatigue, shear stress cracking, or other forms of mechanical failure. To reduce the likelihood of such failure, the casing 131 can reinforce the conduit 130 and receive the strike or pinch from the piston actuator 133. In some embodiments, the casing 131 can be the same material and thickness of the conduit 130, and in some embodiments, it can be made of a stronger or tougher material, or can be thicker than the other portions of the conduit 130.

The piston actuator 133 can be located proximate the conduit 130 and can contact the conduit 130 upon receipt of an electrical signal. The piston actuator 133 can be any device capable of receiving an electrical signal and providing mechanical movement in response so as to trigger one or more droplets 134 from the end of the conduit 130. For example, the piston actuator 133 can be a piezoelectric actuator such as a stack type piezoelectric actuator, a strip type piezoelectric actuator, or a tube type piezoelectric actuator. In this sense, the piston actuator 133 can also be constructed from various piezoelectric materials, such as PZT (lead zirconate titanate), PVDF (polyvinylidene fluoride), or other advanced ceramics that provide efficient conversion of electrical energy into mechanical force. Additionally, the design of the piston actuator 133 might include features such as multi-layer configurations for enhanced performance, precision voltage control for incremental adjustments, and temperature compensation mechanisms to maintain consistent operation under varying environmental conditions. The piston actuator 133 can also be driven by a solenoid-driven mechanism. The

FIG. 2B illustrates a pressure-regulated applicator 115b according to at least some of the presently disclosed embodiments. As shown, the pressure-regulated applicator 115b includes a pressure regulator 136 for regulating the pressure of the system and maintaining the coating in equilibrium. Specifically, displacement of the droplet 134 can cause activation of the pressure regulator 136 to replenish pressure lost from the applicator 115b upon dispensation of the droplet 134. Here, the coating is held within the container 128 and passes through the conduit 130 at least in part due to capillary action. When a droplet 134 is distributed, however, the pressure-regulated applicator 115b replenishes the lost pressure from the now-dispensed droplet 134 through the pressure regulator 136. In particular, the pressure regulator 136 will provide a small amount of pressure to compensate for the lost pressure created by the loss of the droplet 134. The amount of pressure can be enough to cause the system to balance into equilibrium but not enough to cause excessive dispensation of droplets 134.

As discussed above, the pressure regulator 136 is operatively coupled to the container 128 and adapted to provide pressure to cause the coating within the container 128 to reach equilibrium. The pressure regulator 136 can be any device capable of providing pressure to the container 128, for example, a pneumatic pump, a hydraulic actuator, or an electronically controlled solenoid valve.

The position displacement applicator 115a and the pressure-regulated applicator 115b therefore have similarities and differences. Both the position displacement applicator 115a and the pressure-regulated applicator 115b restore the coating within the container 128 to an equilibrium state where it is no longer flowing and also where the void left by the now-dispensed droplet 134 is filled. Other methods can be used to restore the pressure within the container 128, and collectively, all of these methods can be referred to as a pressure restoration system that adjusts a pressure within the container 128 at a time proximate to when the droplet 134 is dispensed by the applicator 115.

As discussed above, the conduit 130 may be coupled to the container 128 at a first opening for receiving the coating and can include a second opening where the droplet 134 exits the applicator 115. The conduit 130 can advantageously be a microstructure such as a micropipe or microchannel, in an exemplary embodiment. The inclusion of a microstructure was also discovered to be particularly advantageous as compared to a more open system. In particular, the present inventors discovered more challenges with the force of gravity in an open system, where the gravitational pull significantly influenced the uncontrolled flow and dispersion of the coating materials. This led to inefficiencies and inconsistencies in coating application. In contrast, the microstructure system offers a more controlled environment where the flow of the coating is considerably resisted due to the surface tension between the coating and the inner surface of the microstructure. This surface tension, along with the capillary forces inherent in the small diameter of the microstructure, counteracts the gravitational forces, leading to a more precise and predictable flow of coating materials. Furthermore, the microstructure enhances the accuracy and uniformity of the coating distribution on targeted surfaces or substrates.

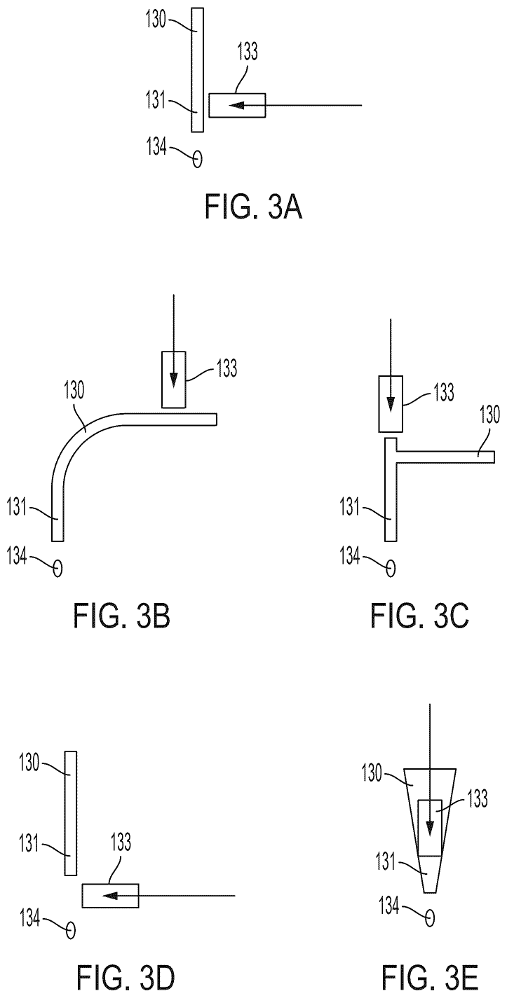

FIGS. 3A-3E illustrate different configurations for a piston actuator 133 applying force to a conduit 130 according to at least some of the presently disclosed embodiments. As shown, in some embodiments, the piston actuator 133 triggers the dispensation of a droplet 134 by striking, tapping, pinching, pushing, or otherwise contacting the end or other portion of the conduit 130. In some embodiments, the piston actuator 133 is placed in a rest position and releases the pressure from the conduit when removed from the rest position. This can be in a “cover” configuration (FIG. 3D) or a valve configuration (FIG. 3E), for example.

Where the piston actuator 133 is a piezoelectric actuator, the piston actuator 133 can receive an electrical signal from a controller, which causes the piston actuator 133 to undergo a rapid dimensional change. This deformation enables the piston actuator 133 to exert a force or displacement, such as making contact with the conduit 130 or removing itself from a rest position within or adjacent to the conduit 130 so as to cause the droplet to be dispensed.

The embodiments of FIGS. 3A-3E illustrate the dispensation action using arrows, and where the conduit 130 includes the casing 131. However, the conduit 130 need not include the casing 131 in some embodiments and the piston actuator 133 can strike an end or other portion of the conduit 130 without the casing 131. Further, as used herein, the term “second opening” can be the opening at which coating exits the conduit 130, whereas the term “first opening” can be the opening within the conduit 130 that receives the coating from, e.g., the container 128. For example, as shown, the casing 131 can be located proximate the second opening.

As shown in FIG. 3A, the piston actuator 133 is positioned along a side of the conduit 130 and contacts the conduit 130 so as to apply a shear force against the conduit 130 when triggered by a voltage signal. Alternatively, or in addition to the above, the piston actuator 133 can strike the top portion of a curved conduit 130 from above, imparting a shear stress farther away from the end of the conduit 130, as shown in FIG. 3B. In some embodiments, the piston actuator 133 can provide an axial force against a top of the conduit 130 to cause the dispensation of a droplet 134, as shown in FIG. 3C.

FIGS. 3D and 3E illustrate embodiments in which the piston actuator 133 does not strike the conduit 130, but rather where the piston actuator 133 is removed from its position within or proximate to an end of the conduit 130 to cause actuation of the droplet. As shown in FIG. 3D, the piston actuator 133 is in a “cover” position while at rest, where the conduit 130 is covered by the piston actuator 133 to prevent the coating from flowing outward. Once the piston actuator 133 is removed, the pressure within the conduit 130 is released and a droplet 134 can be dispensed. Similarly, in FIG. 3E, the piston actuator 133 acts as a valve seat and is positioned within the conduit 130 to prevent passage of the coating. Once removed, the droplet 134 can then be dispensed under the pressure of the conduit 130. Any other manner of releasing pressure within the conduit 130 with the piston actuator 133 can be implemented without departing from the spirit and scope of the present invention.

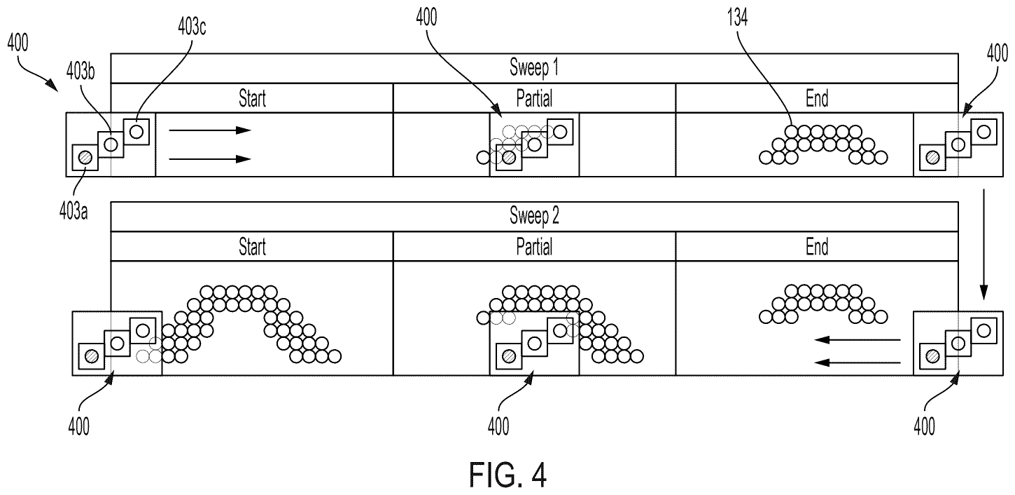

FIG. 4 illustrates two sweeps of a staggered print head configuration according to at least some of the presently disclosed embodiments. As shown, the print head 400 includes a plurality of jets each including respective piston actuators and pipes, where the jets are at least in part positioned in a staggered arrangement. For example, the print head 400 can include a first jet 403a, a second jet 403b, and a third jet 403c that are positioned in a staggered configuration on the print head 400. By staggering the jets 403a-c, the print head 400 includes jets 403a-c that are both parallel and adjacent to one another. This allows the print head 400 to dispense three droplets 134 at a time and print a larger area in one sweep. However, the print head 400 can also turn corners without having to “double back” to fill in gaps due to the staggered arrangement, as shown in the diagram of FIG. 4. The staggered configuration therefore allows for a more efficient print. Of course, three jets 403a-c are illustrated in FIG. 4, but more or fewer jets can be provided without departing from the spirit and scope of the present invention.

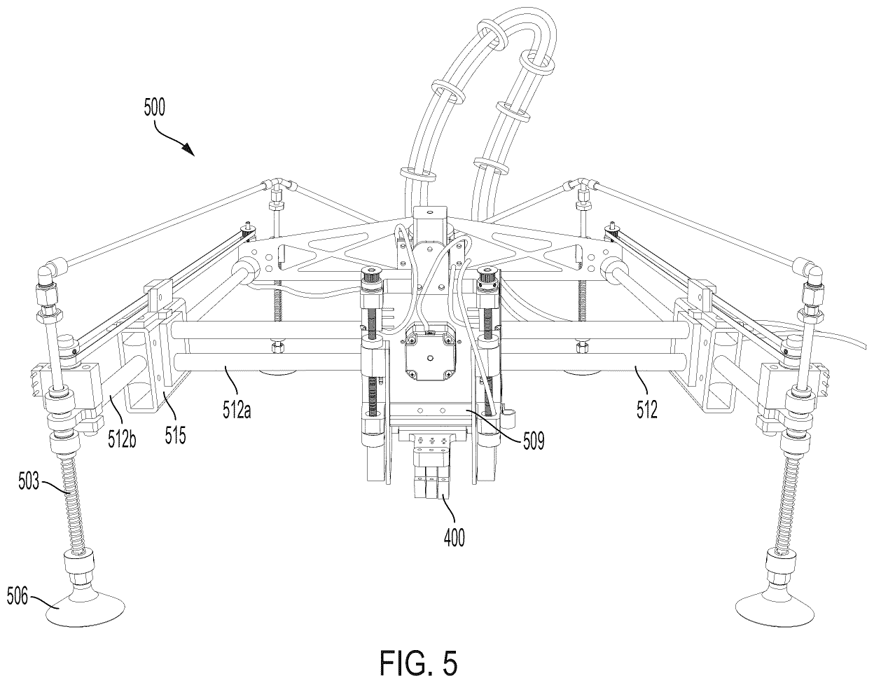

FIG. 5 illustrates a suction cup gantry according to at least some of the presently disclosed embodiments. As shown, the gantry 500 includes legs 503 with suction cups 506 on the ends of the legs 503 to removably couple the gantry 500 to the surface upon which the coating is being applied. The gantry 500 can also include a base 509 with beams 512 coupled thereto, for the purposes of supporting the base 509 and positioning it into engagement. For example, the gantry 500 can be approximately positioned on the substrate surface, and the base 509 can be more precisely positioned by moving the base 509 along the beams 512.

The base 509 can include a motor coupled to the base 509 or associated with it, permitting the base 509 to move horizontally along horizontal beams 512a. Similarly, the gantry 500 can include a gantry motor 515 to move the assembly comprising the base 509 and the horizontal beams 512a along vertical beams 512b to position the base 509 more precisely in the vertical direction. The print head 400 can include a motor that allows upward or downward movement, so as to position it in a more precise location in that direction. Together, the suction cups 506 and motors can precisely position the print head 400 in the correct position for accurate and efficient printing. Further, the suction cups 506 permit a user to hand place the gantry 500 in an approximate position if a larger robotic arm 112 is not available or practical.

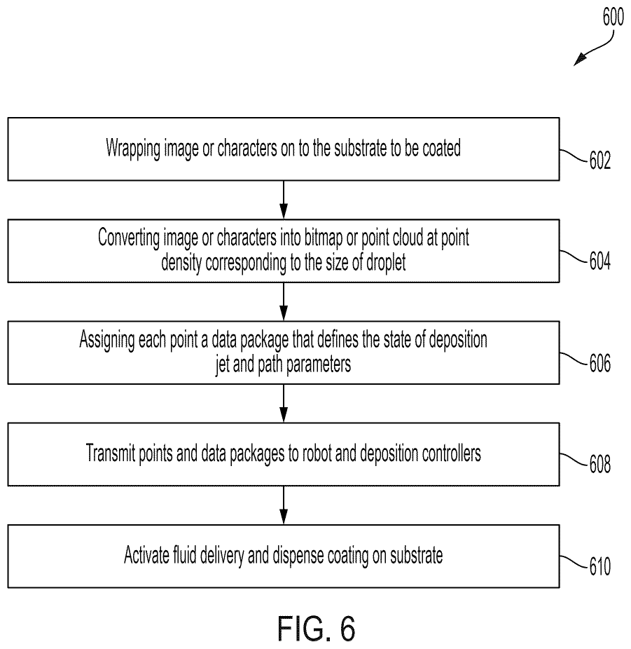

FIG. 6 is a flow chart illustrating a process for depositing coating according to at least some of the presently disclosed embodiments. As shown, the method 600 begins and proceeds to step 602, where an image or characters are wrapped on to the substrate to be coated. For example, the method 600 can obtain a computer-aided drawing (CAD) model of the substrate to be coated, and enter the CAD model into software such as SolidWorks®. The method 600 can then extrapolate the curves of the substrate and create the three-dimensional curves of the image or characters to be printed using a wrap feature.

The method 600 can then advance to step 604, where the image or characters are converted into bitmap or point cloud data at a point density corresponding to the size of the droplet 134. This conversion process ensures that each point or pixel in the data exactly matches the volume and dispersion capabilities of the droplet 134, thus enabling precise control over the deposition of the coating.

The method 600 then proceeds to step 606, where the method 600 assigns each point a data package that defines the state of the deposition jet and the path parameters. For example, the method 600 can create a point package that defines the state of the jets 403a-c as ON (state=1) or OFF (state=0). The path parameters can include the speed of the print head 400 and processing steps to be implemented at a corner or curve of the image, for example.

The method 600 can then proceed to step 608, where the method 600 transmits points and data packages to the robot and deposition controllers. Here, the method 600 streams the above data packages to a queue of a register within a computer, such as the mobile computer 121 discussed above. The robotic arm 112 or other devices can then read the data from the register and move into position to dispense the coating. In step 610, the method can activate the fluid delivery (e.g., the pressure restoration systems discussed above), and dispense the coating on the substrate.

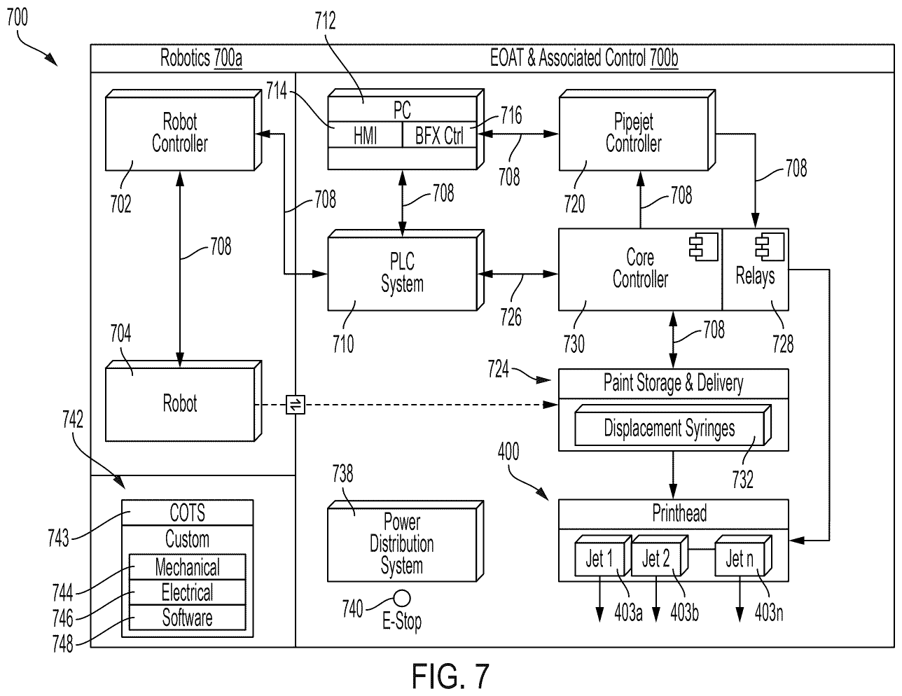

FIG. 7 is a schematic diagram of the system architecture of the robotic deposition system according to at least some of the presently disclosed embodiments. As shown, the system architecture 700 can be conceptually separated into two categories: a robotics 700a component and an End of Arm Tooling (EOAT) and associated control 700b component. However, these components can be intertwined and work together throughout the pre-print and printing process.

As shown, the robot controller 702 can be coupled to a robot 704, such as a robotic arm made by FANUC® Corporation. The robot controller 702 can be coupled by a communication link 709 to provide electrical communication and/or power to the robot 704. The robot controller 702 can also be coupled via a communication link 708 to a programmable logic controller (PLC) system 710, which is itself coupled to a personal computer (PC) 712 with a human-machine interface (HMI) 714 and a piezo actuator controller 716.

The PC 712 may be coupled to a pipejet controller 720 via a communication link 708. The pipejet controller 720 serves as the electrical control hub for the print head 400 and the associated jets 403a-n. For instance, the pipejet controller 720 may be in communication with relays 728 and a core controller 730. The core controller 730 communicates with both the paint storage & delivery system 724 and the pipejet controller 720 to provide synchronized control over the piston actuator 133 and the displacement syringes 732. Specifically, the core controller 730 can instruct the pipejet controller 720 that a first jet 403a and a second jet 403b should dispense a droplet, while the third jet 403c should not. Upon receiving this instruction, the pipejet controller 720 sends a control signal to the relays 728, which in turn activate the appropriate piezoelectric actuators for the first jet 403a and the second jet 403b with a signal “1, 1, 0” indicating activation for the first two jets 403a, b and deactivation for the third jet 403c. The relays 728 ensure precise electrical control, coordinating the delivery of voltage signals to the respective jets. Simultaneously, or immediately after, the core controller 730 interacts with the paint storage & delivery system 724 to adjust the displacement syringes 732, compensating for the volume of paint dispensed by the jets 403a-c. This integrated control system ensures accurate and synchronized operation of the print head 400.

The system architecture 700 can also include a power distribution system 738 with an emergency stop 740. This emergency stop 740 is designed to immediately halt all operational aspects of the system in the event of a safety concern or system failure. It is strategically integrated into the power distribution system 738 to ensure rapid disengagement of power to critical components, thereby preventing damage or hazards. The power distribution system 738 itself is configured to manage and allocate electrical power across various subsystems of the system architecture 700 efficiently. It includes circuit breakers, voltage regulators, and redundancy circuits to maintain stable and continuous operations under varying load conditions.

The system architecture 700 can also include software programs, applications, utilities, and other tools designed to manage or control the various physical components of the system architecture 700. For example, the system architecture 700 can include a software package 742 including commercial off-the-shelf software (COTS) 743, as well as custom mechanical software 744, custom electrical software 746, and other custom software 748 such as the operating system or other software management tools.

The term “communication link 708” is intended to broadly encompass any electrical connection between two electrical devices. For example, the communication link 708 may be a wired connection such as a USB cable, an Ethernet cable, or any other type of data cable which facilitates the transfer of information. Alternatively, the communication link 708 may also include wireless communication technologies such as Bluetooth, Wi-Fi, NFC (Near Field Communication), or cellular networks, which allow data to be exchanged over distances without the need for physical connectors. Additionally, the communication link 708 may be a link intended solely for the transmission of power to one or more electrical devices.

In several embodiments, the applied material has been referred to as a “paint.” However, any coating can be implemented by the present invention, including paint, varnish, lacquer, stain, primer, sealant, enamel, epoxy, polyurethane, acrylic, silicone, ceramic coatings, powder coatings, and thermal spray coatings. These coatings may be applied for various purposes such as aesthetics, protection against environmental conditions, corrosion resistance, scratch resistance, or to enhance surface properties like hydrophobicity or conductivity. Each type of coating can be tailored to meet the specific needs of the substrate and the performance requirements of the application.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

Further, it should be appreciated that in the appended claims, reference to an element in the singular is not intended to mean “one and only one” unless explicitly so stated, but rather “one or more.”

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

The words “illustrative” or “exemplary” are used herein to mean “serving as an example, instance, or illustration.” Any aspect described herein as “illustrative” or “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

What is claimed is:

1. A coating deposition system for dispensing a coating, the coating deposition system comprising:
a robotic arm; and
an applicator coupled to and movable by the robotic arm, the applicator including:
a container that maintains the coating in a closed configuration;
a pressure restoration system that adjusts a pressure within the container at a time proximate to when a droplet is dispensed by the applicator;
a conduit including at least a first opening coupled to the container for receiving the coating and a second opening where the droplet exits the applicator; and
a piston actuator located proximate the conduit and releasing pressure within the conduit upon receipt of an electrical signal.

2. The coating deposition system of claim 1, wherein the pressure restoration system includes a pressure regulator, wherein displacement of the droplet causes activation of the pressure regulator to replenish pressure lost from the applicator upon dispensation of the droplet.

3. The coating deposition system of claim 1, wherein the pressure restoration system includes a pump, wherein displacement of the droplet causes activation of the pump to replenish pressure lost from the applicator upon dispensation of the droplet.

4. The coating deposition system of claim 3, further comprising a computer with a storage and processor, the processor capable of executing instructions to:
cause the piston actuator to release the pressure in the conduit so as to cause dispensation of the droplet; and
cause the activation of the pump to replenish the pressure lost from the applicator upon the dispensation of the droplet in a coordinated manner.

5. The coating deposition system of claim 3, wherein the pump is at least one of a syringe pump including a motor coupled to a linear actuator, a pneumatically driven syringe, and a pneumatically driven pressure regulator.

6. The coating deposition system of claim 1, wherein the conduit is a microstructure and wherein the coating passes through the microstructure at least in part due to capillary action.

7. The coating deposition system of claim 1, wherein the applicator includes a plurality of jets each including respective piston actuators and conduits, the jets at least in part positioned in a staggered arrangement.

8. The coating deposition system of claim 1, wherein the piston actuator is positioned adjacent the conduit and contacts the conduit so as to apply a force against the conduit and release the pressure from the conduit.

9. The coating deposition system of claim 1, wherein the piston actuator is placed in a rest position and releases the pressure from the conduit when removed from the rest position.

10. The coating deposition system of claim 1, wherein the conduit includes a casing proximate the second opening.

11. An applicator for a coating deposition system that dispenses a coating, the applicator comprising:
a container that maintains the coating in a closed configuration;
a pressure restoration system that adjusts a pressure within the container at a time proximate to when a droplet is dispensed by the applicator;
a conduit including at least a first opening coupled to the container for receiving the coating and a second opening where the droplet exits the applicator; and
a piston actuator located proximate the conduit and releasing pressure within the conduit upon receipt of an electrical signal.

12. The applicator of claim 11, wherein the pressure restoration system includes a pressure regulator, wherein displacement of the droplet causes activation of the pressure regulator to replenish pressure lost from the applicator upon dispensation of the droplet.

13. The applicator of claim 11, wherein the pressure restoration system includes a pump, wherein displacement of the droplet causes activation of the pump to replenish pressure lost from the applicator upon dispensation of the droplet.

14. The applicator of claim 13, further comprising a computer with a storage and processor, the processor capable of executing instructions to:
cause the piston actuator to release the pressure in the conduit so as to cause dispensation of the droplet; and
cause the activation of the pump to replenish the pressure lost from the applicator upon the dispensation of the droplet in a coordinated manner.

15. The applicator of claim 13, wherein the pump is at least one of a syringe pump including a motor coupled to a linear actuator, a pneumatically driven syringe, and a pneumatically driven pressure regulator.

16. The applicator of claim 11, wherein the conduit is a microstructure and wherein the coating passes through the microstructure at least in part due to capillary action.

17. The applicator of claim 11, further comprising a plurality of jets each including respective piston actuators and conduits, the jets at least in part positioned in a staggered arrangement.

18. The applicator of claim 11, wherein the piston actuator is positioned adjacent the conduit and contacts the conduit so as to apply a force against the conduit and release the pressure from the conduit.

19. The applicator of claim 11, wherein the piston actuator is placed in a rest position and releases the pressure from the conduit when removed from the rest position.

20. The applicator of claim 11, wherein the conduit includes a casing proximate the second opening.
